(19) United States
(12) Patent Application Publication
(10) Pub. No.: US 2024/0035115 A1
(43) Pub. Date: Feb. 1, 2024

(54) METHOD FOR PRODUCING FERRONICKEL AND REMOVING CHROMIUM FROM NICKEL LATERITE ORE

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN)

(72) Inventors: Haijun Yu, Foshan (CN); Aixia Li, Foshan (CN); Yinghao Xie, Foshan (CN); Xuemei Zhang, Foshan (CN); Changdong Li, Foshan (CN)

(21) Appl. No.: 18/225,101

(22) Filed: Jul. 21, 2023

Related U.S. Application Data
(63) Continuation of application No. PCT/CN2022/117476, filed on Sep. 7, 2022.

(30) Foreign Application Priority Data
Jul. 29, 2022 (CN) 202210906191.2

(51) Int. Cl. C22B 23/02; C22B 23/00; C22B 34/32; C22B 3/10

(52) U.S. Cl. CPC C22B 23/023; C22B 23/005; C22B 34/32; C22B 3/10

(57) ABSTRACT

A method for producing ferronickel and removing chromium from nickel laterite ore, including the following steps: (1) subjecting the nickel laterite ore to ore washing and separating to obtain an ore slurry and a mineral aggregate, adding an alkali liquor and a bromate and introducing oxygen to the ore slurry to allow oxidation leaching, and then conducting solid-liquid separation to obtain a solid and a chromium-containing filtrate; (2) subjecting the solid obtained in step (1) to washing and solid-liquid separation to obtain a solid phase and washing water, and mixing the solid phase with quicklime and a reducing agent to obtain a mixture; and (3) subjecting the mixture obtained in step (2) to roasting and smelting successively to obtain a finished ferronickel product. The method achieves enrichment of chromium, and produces ferronickel through smelting of the nickel laterite ore while removing the impurity chromium, protecting the safety of a furnace.

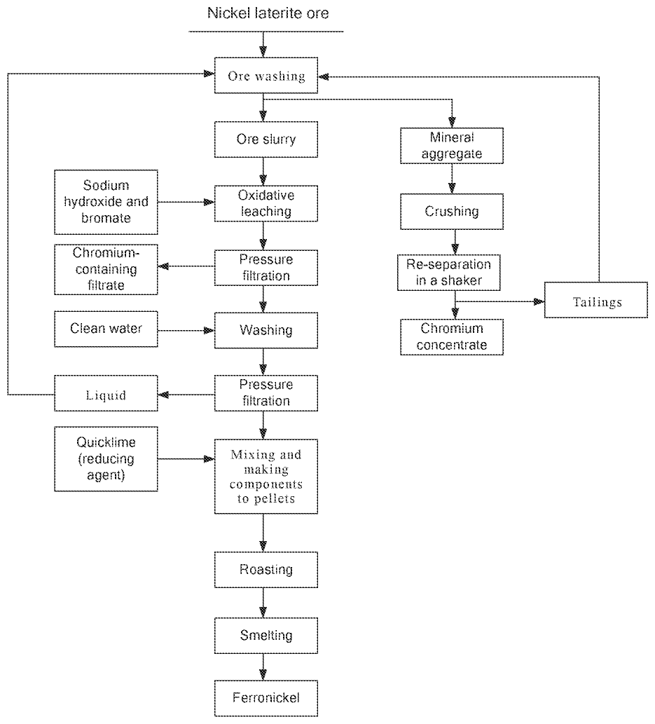

### CROSS-REFERENCE TO RELATED APPLICATIONS

The present application is a continuation application of PCT application No. PCT/CN2022/117476 filed on Sep. 7, 2022, which claims the benefit of Chinese Patent Application No. 202210906191.2 filed on Jul. 29, 2022. The contents of all of the aforementioned applications are incorporated by reference herein in their entirety.

### TECHNICAL FIELD

The present disclosure belongs to the technical field of metallurgy, and in particular relates to a method for producing ferronickel and removing chromium from nickel laterite ore.

### BACKGROUND

With the widespread application of stainless steels and special steels around the world, nickel metal, as the most important element for smelting of stainless steels and special steels, is in short supply and is increasingly expensive. Traditionally, nickel metal is mainly extracted from nickel sulfide ores which account for 30% of the earth's nickel resources, and a corresponding production process is mature. However, after being continuously exploited for nearly a hundred years, nickel reserves are currently insufficient, causing a nickel resource crisis. Thus, nickel laterite ores (nickel oxide ores) which account for 70% of the earth's nickel resources have attracted people's attention, and attempts have been made to extract nickel from nickel laterite ore.

Nickel laterite ore is a loose clay-like aggregate including oxides of nickel, iron, magnesium, cobalt, silicon, aluminum, and the like that is formed due to a long-term geological action of a nickel-containing olivine bedrock. Iron element in the nickel laterite ore is in a +3 valence state due to heavy oxidation, such that the nickel laterite ore is reddish-brown overall, which is the origin of its name. At present, the nickel laterite ore is mainly developed by a fire process (mainly a rotary kiln-electric furnace (RKEF) ferronickel production process) and a wet process (mainly a high-pressure acid-leaching process).

Because nickel laterite ore often includes Cr₂O₃ and chromium has a very high melting point. Nickel and chromium-containing molten iron produced during the fire process has a high viscosity and thus cannot flow out smoothly, resulting in serious consequences such as furnace condensation and furnace destruction. A lot of research has been conducted by many enterprises and research institutions on a process for producing ferronickel through one-step blast furnace from nickel laterite ore, but so far the process has not been successfully developed. The wet process, especially the high-pressure acid-leaching process, will cause corrosion to the equipment, and the spinel-type chromite in the nickel laterite ore also has a strong abrasive effect on the equipment. Therefore, when nickel laterite ore is subjected to the wet process, expensive corrosion-resistant equipment is required, which increases an equipment cost and brings unpredictable safety risks.

Therefore, either in the wet process or in the fire process, nickel laterite ore needs to undergo chromium removal, that is, chromite needs to be removed from the nickel laterite ore through a chromium removal process. However, in an actual smelting process, chromium, as an important metal element, is mostly discarded, so that the comprehensive utilization of resources cannot be achieved. In particular, during the fire process, the smelting of ferronickel has high requirements for a chromium content in the nickel laterite ore (the chromium content should be no more than 0.1%). Therefore, there is an urgent need for a process that can remove chromium during smelting of nickel laterite ore and can obtain qualified chromium concentrate while removing chromium, which achieves the comprehensive utilization of resources and facilitates the full use of chromium resources.

### SUMMARY

The present disclosure is intended to solve at least one of the technical problems existing in the prior art. In view of this, the present disclosure provides a method for producing ferronickel and removing chromium from nickel laterite ore. The method can achieve enrichment of chromium, and produces ferronickel through smelting of the nickel laterite ore while removing the impurity chromium, which can protect the safety of a furnace and facilitate the full use of chromium resources.

The above technical objective of the present disclosure is achieved by the following technical solutions.

A method for producing ferronickel and removing chromium from nickel laterite ore is provided, including the following steps:
(1) subjecting the nickel laterite ore to ore washing and separating to obtain an ore slurry and a mineral aggregate, adding an alkali liquor and a bromate and introducing oxygen to the ore slurry to allow oxidation leaching, and then conducting solid-liquid separation to obtain a solid and a chromium-containing filtrate;
(2) subjecting the solid obtained in step (1) to washing and solid-liquid separation to obtain a solid phase and washing water, and mixing the solid phase with quicklime and a reducing agent to obtain a mixture; and
(3) subjecting the mixture obtained in step (2) to roasting and smelting successively to obtain a finished ferronickel product.

Preferably, in step (1), the ore slurry has a solid content of 10% to 25%.

Further preferably, in step (1), the ore slurry has a solid content of 15% to 20%.

Preferably, the method further includes: subjecting the mineral aggregate obtained in step (1) to crushing and re-separation in a shaker to obtain chromium concentrate and tailings, and returning the tailings for the ore washing.

Preferably, the chromium-containing filtrate and the chromium concentrate may be sent to a chromium processing plant for further treatment.

Preferably, in step (1), the mineral aggregate is crushed to a particle size of less than 2 mm and then subjected to re-separation in the shaker.

Further preferably, in step (1), the mineral aggregate is crushed to a particle size of less than 1.5 mm and then subjected to re-separation in the shaker.

Preferably, in step (1), during the re-separation in the shaker, the shaker has a water flow rate of 1 L/min to 5 L/min.

Further preferably, in step (1), during the re-separation in the shaker, the shaker has a water flow rate of 3 L/min to 4 L/min.

Preferably, in step (1), the nickel laterite ore is subjected to ore washing and separation in a cylindrical ore washer, a trough ore washer, and a hydrocyclone successively, wherein the ore washing is conducted with water and the hydrocyclone gives nickel laterite ore with a particle size of 0.05 mm.

Preferably, in step (1), for the oxidation leaching, a mass ratio of the alkali liquor to the bromate to the ore slurry is (0.5-1):(1-2):100.

Further preferably, in step (1), for the oxidation leaching, a mass ratio of the alkali liquor to the bromate to the ore slurry is (0.8-1):(1-1.5):100.

Preferably, in step (1), the oxidation leaching is conducted in a closed state, and a pressure of the oxygen is 1.5 MPa to 4 MPa.

Further preferably, in step (1), the oxidation leaching is conducted under an enclosed condition, and a pressure of the oxygen is 2 MPa to 3 MPa.

Preferably, in step (1), the oxidation leaching is conducted at a temperature of 100° C. to 150° C. for 1 h to 5 h.

Further preferably, in step (1), the oxidation leaching is conducted at a temperature of 110° C. to 130° C. for 2 h to 4 h.

Preferably, in step (1), the oxidation leaching is conducted under stirring at a rotational speed of 100 r/min to 500 r/min.

Further preferably, in step (1), the oxidation leaching is conducted under stirring at a rotational speed of 200 r/min to 300 r/min.

Preferably, in step (1), the alkali liquor is at least one selected from the group consisting of sodium hydroxide and potassium hydroxide.

Preferably, in step (1), the bromate is at least one selected from the group consisting of potassium bromate and sodium bromate.

Preferably, the washing water obtained in step (2) is returned to step (1) for the ore washing.

Preferably, in step (2), a mass ratio of the quicklime to the reducing agent to the solid phase is (2-10):(3-8):100.

Further preferably, in step (2), a mass ratio of the quicklime to the reducing agent to the solid phase is (4-10):(4-8):100.

Preferably, in step (2), the reducing agent is at least one selected from the group consisting of anthracite and semi-coke.

Preferably, in step (3), the mixture is further granulated to a particle size of 10 mm to 30 mm before being roasted.

Further preferably, in step (3), the mixture is further granulated to a particle size of 15 mm to 20 mm before being roasted.

Preferably, in step (3), the roasting is conducted at a temperature of 600° C. to 1,000° C. for 10 min to 50 min.

Further preferably, in step (3), the roasting is conducted at a temperature of 800° C. to 900° C. for 20 min to 30 min.

Preferably, in step (3), the smelting is conducted at a temperature greater than or equal to 1,500° C.

Further preferably, in step (3), the smelting is conducted at a temperature greater than or equal to 1,600° C.

Preferably, a method for producing ferronickel and removing chromium from nickel laterite ore is provided, including the following steps:
(1) subjecting the nickel laterite ore as raw ore to ore washing and separation in a cylindrical ore washer, a trough ore washer, and a hydrocyclone successively to obtain an ore slurry and a mineral aggregate, wherein the ore washing is conducted with water, the hydrocyclone gives nickel laterite ore with a particle size of 0.05 mm, and a solid content of the ore slurry is controlled at 15% to 20%; subjecting the ore slurry to oxidation leaching, subjecting the mineral aggregate to crushing to a particle size of 1.5 mm or less and re-separation in a shaker with a water flow rate of 3 L/min to 4 L/min to obtain chromium concentrate and tailings, and returning the tailings to the ore washing procedure;
(2) adding sodium hydroxide and a bromate (potassium/sodium bromate) to the ore slurry in a mass ratio of sodium hydroxide to the bromate (potassium/sodium bromate) to the ore slurry of (0.8-1):(1-1.5):100, introducing oxygen under an oxygen pressure of 2 MPa to 3 MPa, and under an enclosed condition, heating a resulting system to 110° C. to 130° C. to allow oxidation leaching for 2 h to 4 h under stirring at a rotational speed of 200 r/min to 300 r/min;
(3) after the oxidation leaching in step (2) is completed, conducting solid-liquid separation by a pressure filter to obtain a chromium-containing filtrate and a filter cake, and sending the chromium-containing filtrate and the chromium concentrate to a chromium processing plant;
(4) subjecting the filter cake to further washing with clean water and pressure filtration to obtain a liquid and a solid, and sending the liquid for the ore washing and using the solid in the following step;
(5) mixing quicklime, a reducing agent, and the solid obtained in step (4) in a mass ratio of (4-10):(4-8):100 and making a resulting mixture to pellets with a particle size of 15 mm to 20 mm, wherein the reducing agent is at least one selected from the group consisting of anthracite and semi-coke;
(6) subjecting the pellets to roasting in a rotary kiln at a temperature of 800° C. to 900° C. for 20 min to 30 min; and
(7) subjecting the roasted pellets to smelting in an electric furnace at a temperature greater than or equal to 1,600° C. to obtain a finished ferronickel product.

The present disclosure has the following beneficial effects:
(1) In the method for producing ferronickel and removing chromium from nickel laterite ore of the present disclosure, the nickel laterite ore is subjected to ore washing and separation to obtain an ore slurry and a mineral aggregate, and then the ore slurry is subjected to oxidation leaching. Due to strong oxidizability of the bromate under alkaline conditions and use of oxygen for oxidation leaching, chromic oxide is oxidized and dissolved in an alkaline solution to produce sodium chromate, thereby separating the chromium element. The method of the present disclosure further reduces a chromium content in a raw material for ferronickel smelting, protects a furnace, and reduces a chromium impurity content in ferronickel. A reaction principle is as follows:

Oxidation leaching:

5Cr₂O₃+14NaOH+6NaBrO₃→10Na₂CrO₄+3Br₂+7H₂O

6NaOH+3Br₂→5NaBr+NaBrO₃+3H₂O

4NaBr+O₂+2H₂O=4NaOH+2Br₂

2Cr₂O₃+8NaOH+3O₂→4Na₂CrO₄+4H₂O
(2) In the method for producing ferronickel and removing chromium from nickel laterite ore of the present disclosure, after the ore slurry and the mineral aggregate are obtained through ore washing and separation, since the ore slurry has a low chromium content, oxidation leaching is used to extract the chromium element in the ore slurry into a leaching solution, and then a resulting mixture is subjected to solid-liquid separation; besides, the mineral aggregate with a high chromium content is further crushed and subjected to re-separation to obtain chromium concentrate with a high density and tailings with a low chromium content, and the tailings can be returned to the ore washing procedure, which avoids a waste of resources.
(3) In the method for producing ferronickel and removing chromium from nickel laterite ore of the present disclosure, by subjecting the nickel laterite ore to separation, ferronickel is obtained while the chromium element is extracted, so that a chromium content in the finished ferronickel product is reduced. In addition, the liquid resulting from washing of the solid obtained after the oxidation leaching is returned for the ore washing, which further reduces the water consumption, realizes the comprehensive utilization of resources, and improves the mining value of nickel laterite ore.

### BRIEF DESCRIPTION OF THE DRAWINGS

The sole FIGURE is a schematic diagram illustrating a process flow of a method of Example 1 of the present disclosure.

### DETAILED DESCRIPTION

The present disclosure is further described below in conjunction with specific examples. The particle size and composition of the nickel laterite ore used in Examples 1 to 3 and Comparative Examples 1 to 4 are shown in Table 1, wherein the term yield refers to the percentage of the relevant particle size in the whole.

TABLE 1
Particle size and composition of the nickel laterite ore

| Particle size/mm | Yield/% | Ni | Fe | MgO | Al₂O₃ | Cr₂O₃ | Co | SiO₂ |
|---|---|---|---|---|---|---|---|---|
| ≥10 | 0.51 | 1.31 | 7.09 | 30.76 | 2.92 | 0.5 | 0.02 | 39.37 |
| 10 > x ≥ 3 | 0.75 | 0.6 | 18.34 | 17.84 | 6.68 | 1.2 | 0.07 | 32.08 |
| 3 > x ≥ 2 | 0.31 | 0.43 | 17.51 | 19.37 | 6.09 | 1.26 | 0.06 | 35.56 |
| 2 > x ≥ 1 | 0.6 | 0.32 | 12.6 | 22.14 | 5.7 | 1.24 | 0.06 | 39.43 |
| 1 > x ≥ 0.55 | 0.72 | 0.37 | 10.5 | 24.07 | 6.3 | 1.82 | 0.13 | 10.92 |
| 0.55 > x ≥ 0.2 | 2.57 | 0.66 | 13.33 | 19.9 | 9.84 | 5.53 | 0.31 | 32.12 |
| 0.2 > x ≥ 0.1 | 0.71 | 0.75 | 17.73 | 14.87 | 14.43 | 10.74 | 0.32 | 21.88 |
| 0.1 > x ≥ 0.05 | 3.01 | 0.93 | 23.88 | 10.85 | 12.91 | 7.91 | 0.34 | 18.51 |
| 0.05 > x | 90.82 | 1.14 | 43.38 | 1.16 | 7.43 | 2.35 | 0.08 | 6.71 |
| Total | 100 | 1.1 | 40.96 | 2.65 | 7.66 | 2.63 | 0.1 | 8.71 |

### Example 1

As shown in the sole FIGURE, a method for producing ferronickel and removing chromium from nickel laterite ore was provided, including the following steps:
(1) the nickel laterite ore as raw ore was subjected to ore washing in a cylindrical ore washer, a trough ore washer, and a hydrocyclone successively and separation to obtain an ore slurry and a mineral aggregate, wherein the ore washing is conducted with water, the hydrocyclone gives nickel laterite ore with a particle size of 0.05 mm, and a solid content of the ore slurry is controlled at 20%; the ore slurry was subjected to oxidation leaching, the mineral aggregate was subjected to crushing to a particle size of 1.5 mm or less and re-separation in a shaker with a water flow rate of 4 L/min to obtain chromium concentrate and tailings, and the tailings were returned to the ore washing procedure;
(2) sodium hydroxide and sodium bromate were added to the ore slurry in a mass ratio of sodium hydroxide to sodium bromate to the ore slurry of 1:1.5:100, oxygen was introduced under an oxygen pressure of 3 MPa, and under an enclosed condition, a resulting system was heated to 130° C. to allow oxidation leaching for 2 h under stirring at a rotational speed of 200 r/min;
(3) after the oxidation leaching in step (2) was completed, solid-liquid separation was conducted by a pressure filter to obtain a chromium-containing filtrate and a filter cake, and the chromium-containing filtrate and the chromium concentrate were sent to a chromium processing plant;
(4) the filter cake was subjected to further washing with clean water and pressure filtration to obtain a liquid and a solid, and the liquid was sent for the ore washing and the solid was used in the following step;
(5) quicklime, semi-coke, and the solid obtained in step (4) were mixed in a mass ratio of 10:8:100 and a resulting mixture was made to pellets with a particle size of 20 mm;
(6) the pellets were subjected to roasting in a rotary kiln at a temperature of 900° C. for 20 min; and
(7) the roasted pellets were subjected to smelting in an electric furnace at a temperature of 1,600° C. to obtain a finished ferronickel product.

### Example 2

A method for producing ferronickel and removing chromium from nickel laterite ore was provided, including the following steps:
(1) the nickel laterite ore as raw ore was subjected to ore washing in a cylindrical ore washer, a trough ore washer, and a hydrocyclone successively and separation to obtain an ore slurry and a mineral aggregate, wherein the ore washing is conducted with water, the hydrocyclone gives nickel laterite ore with a particle size of 0.05 mm, and a solid content of the ore slurry is controlled at 18%; the ore slurry was subjected to oxidation leaching, the mineral aggregate was subjected to crushing to a particle size of 1.5 mm or less and re-separation in a shaker with a water flow rate of 3.5 L/min to obtain chromium concentrate and tailings, and the tailings were returned to the ore washing procedure;
(2) sodium hydroxide and sodium bromate were added to the ore slurry in a mass ratio of sodium hydroxide to sodium bromate to the ore slurry of 0.9:1.3:100, oxygen was introduced under an oxygen pressure of 2.5 MPa, and under an enclosed condition, a resulting system was heated to 120° C. to allow oxidation leaching for 3 h under stirring at a rotational speed of 250 r/min;
(3) after the oxidation leaching in step (2) was completed, solid-liquid separation was conducted by a pressure filter to obtain a chromium-containing filtrate and a filter cake, and the chromium-containing filtrate and the chromium concentrate were sent to a chromium processing plant;
(4) the filter cake was subjected to further washing with clean water and pressure filtration to obtain a liquid and a solid, and the liquid was sent for the ore washing and the solid was used in the following step;
(5) quicklime, semi-coke, and the solid obtained in step (4) were mixed in a mass ratio of 7:6:100 and a resulting mixture was made to pellets with a particle size of 17 mm;
(6) the pellets were subjected to roasting in a rotary kiln at a temperature of 850° C. for 25 min; and
(7) the roasted pellets were subjected to smelting in an electric furnace at a temperature of 1,700° C. to obtain a finished ferronickel product.

### Example 3

A method for producing ferronickel and removing chromium from nickel laterite ore was provided, including the following steps:
(1) the nickel laterite ore as raw ore was subjected to ore washing in a cylindrical ore washer, a trough ore washer, and a hydrocyclone successively and separation to obtain an ore slurry and a mineral aggregate, wherein the ore washing is conducted with water, the hydrocyclone gives nickel laterite ore with a particle size of 0.05 mm, and a solid content of the ore slurry is controlled at 15%; the ore slurry was subjected to oxidation leaching, the mineral aggregate was subjected to crushing to a particle size of 1.5 mm or less and re-separation in a shaker with a water flow rate of 3 L/min to obtain chromium concentrate and tailings, and the tailings were returned to the ore washing procedure;
(2) sodium hydroxide and potassium bromate were added to the ore slurry in a mass ratio of sodium hydroxide to sodium bromate to the ore slurry of 0.8:1:100, oxygen was introduced under an oxygen pressure of 2 MPa, and under an enclosed condition, a resulting system was heated to 110° C. to allow oxidation leaching for 4 h under stirring at a rotational speed of 300 r/min;
(3) after the oxidation leaching in step (2) was completed, solid-liquid separation was conducted by a pressure filter to obtain a chromium-containing filtrate and a filter cake, and the chromium-containing filtrate and the chromium concentrate were sent to a chromium processing plant;
(4) the filter cake was subjected to further washing with clean water and pressure filtration to obtain a liquid and a solid, and the liquid was sent for the ore washing and the solid was used in the following step;
(5) quicklime, anthracite, and the solid obtained in step (4) were mixed in a mass ratio of 4:4:100 and a resulting mixture was made to pellets with a particle size of 15 mm;
(6) the pellets were subjected to roasting in a rotary kiln at a temperature of 800° C. for 30 min; and
(7) the roasted pellets were subjected to smelting in an electric furnace at a temperature of 1,800° C. to obtain a finished ferronickel product.

### Comparative Example 1 (Which Was Different from Example 1 Only in That the High-Pressure Oxygen Was Not Introduced During the Oxidation Leaching of the Ore Slurry)

A method for producing ferronickel and removing chromium from nickel laterite ore was provided, including the following steps:
(1) the nickel laterite ore as raw ore was subjected to ore washing in a cylindrical ore washer, a trough ore washer, and a hydrocyclone successively and separation to obtain an ore slurry and a mineral aggregate, wherein the ore washing is conducted with water, the hydrocyclone gives nickel laterite ore with a particle size of 0.05 mm, and a solid content of the ore slurry is controlled at 20%; the ore slurry was subjected to oxidation leaching, the mineral aggregate was subjected to crushing to a particle size of 1.5 mm or less and re-separation in a shaker with a water flow rate of 4 L/min to obtain chromium concentrate and tailings, and the tailings were returned to the ore washing procedure;
(2) sodium hydroxide and sodium bromate were added to the ore slurry in a mass ratio of sodium hydroxide to sodium bromate to the ore slurry of 1:1.5:100, and under an enclosed condition, a resulting system was heated to 130° C. to allow a reaction for 2 h under stirring at a rotational speed of 200 r/min;
(3) after the oxidation leaching in step (2) was completed, solid-liquid separation was conducted by a pressure filter to obtain a chromium-containing filtrate and a filter cake, and the chromium-containing filtrate and the chromium concentrate were sent to a chromium processing plant;
(4) the filter cake was subjected to further washing with clean water and pressure filtration to obtain a liquid and a solid, and the liquid was sent for the ore washing and the solid was used in the following step;
(5) quicklime, semi-coke, and the solid obtained in step (4) were mixed in a mass ratio of and a resulting mixture was made to pellets with a particle size of 20 mm;
(6) the pellets were subjected to roasting in a rotary kiln at a temperature of 900° C. for 20 min; and
(7) the roasted pellets were subjected to smelting in an electric furnace at a temperature of 1,600° C. to obtain a finished ferronickel product.

### Comparative Example 2 (Which Was Different from Example 2 Only in That the High-Pressure Oxygen Was Not Introduced During the Oxidation Leaching of the Ore Slurry)

A method for producing ferronickel and removing chromium from nickel laterite ore was provided, including the following steps:
(1) the nickel laterite ore as raw ore was subjected to ore washing in a cylindrical ore washer, a trough ore washer, and a hydrocyclone successively and separation to obtain an ore slurry and a mineral aggregate, wherein the ore washing is conducted with water, the hydrocyclone gives nickel laterite ore with a particle size of 0.05 mm, and a solid content of the ore slurry is controlled at 18%; the ore slurry was subjected to oxidation leaching, the mineral aggregate was subjected to crushing to a particle size of 1.5 mm or less and re-separation in a shaker with a water flow rate of 3.5 L/min to obtain chromium concentrate and tailings, and the tailings were returned to the ore washing procedure;
(2) sodium hydroxide and sodium bromate were added to the ore slurry in a mass ratio of sodium hydroxide to sodium bromate to the ore slurry of 0.9:1.3:100, and under an enclosed condition, a resulting system was heated to 120° C. to allow oxidation leaching for 3 h under stirring at a rotational speed of 250 r/min;
(3) after the oxidation leaching in step (2) was completed, solid-liquid separation was conducted by a pressure filter to obtain a chromium-containing filtrate and a filter cake, and the chromium-containing filtrate and the chromium concentrate were sent to a chromium processing plant;
(4) the filter cake was subjected to further washing with clean water and pressure filtration to obtain a liquid and a solid, and the liquid was sent for the ore washing and the solid was used in the following step;
(5) quicklime, semi-coke, and the solid obtained in step (4) were mixed in a mass ratio of 7:6:100 and a resulting mixture was made to pellets with a particle size of 17 mm;
(6) the pellets were subjected to roasting in a rotary kiln at a temperature of 850° C. for 25 min; and
(7) the roasted pellets were subjected to smelting in an electric furnace at a temperature of 1,700° C. to obtain a finished ferronickel product.

### Comparative Example 3 (Which Was Different from Example 3 Only in That the High-Pressure Oxygen Was Not Introduced During the Oxidation Leaching of the Ore Slurry)

A method for producing ferronickel and removing chromium from nickel laterite ore was provided, including the following steps:
(1) the nickel laterite ore as raw ore was subjected to ore washing in a cylindrical ore washer, a trough ore washer, and a hydrocyclone successively and separation to obtain an ore slurry and a mineral aggregate, wherein the ore washing is conducted with water, the hydrocyclone gives nickel laterite ore with a particle size of 0.05 mm, and a solid content of the ore slurry is controlled at 15%; the ore slurry was subjected to oxidation leaching, the mineral aggregate was subjected to crushing to a particle size of 1.5 mm or less and re-separation in a shaker with a water flow rate of 3 L/min to obtain chromium concentrate and tailings, and the tailings were returned to the ore washing procedure;
(2) sodium hydroxide and potassium bromate were added to the ore slurry in a mass ratio of sodium hydroxide to sodium bromate to the ore slurry of 0.8:1:100, and under an enclosed condition, a resulting system was heated to 110° C. to allow oxidation leaching for 4 h under stirring at a rotational speed of 300 r/min;
(3) after the oxidation leaching in step (2) was completed, solid-liquid separation was conducted by a pressure filter to obtain a chromium-containing filtrate and a filter cake, and the chromium-containing filtrate and the chromium concentrate were sent to a chromium processing plant;
(4) the filter cake was subjected to further washing with clean water and pressure filtration to obtain a liquid and a solid, and the liquid was sent for the ore washing and the solid was used in the following step;
(5) quicklime, anthracite, and the solid obtained in step (4) were mixed in a mass ratio of 4:4:100 and a resulting mixture was made to pellets with a particle size of 15 mm;
(6) the pellets were subjected to roasting in a rotary kiln at a temperature of 800° C. for 30 min; and
(7) the roasted pellets were subjected to smelting in an electric furnace at a temperature of 1,800° C. to obtain a finished ferronickel product.

### Comparative Example 4

A method for producing ferronickel by smelting nickel laterite ore was provided, including the following steps:
(1) the nickel laterite ore as raw ore was subjected to ore washing in a cylindrical ore washer, a trough ore washer, and a hydrocyclone successively and separation to obtain an ore slurry and a mineral aggregate, wherein the ore washing is conducted with water, the hydrocyclone gives nickel laterite ore with a particle size of 0.05 mm, and a solid content of the ore slurry is controlled at 15%;
(2) quicklime and semi-coke were added into the ore slurry obtained in step (1) in a mass ratio of the ore slurry to quicklime to semi-coke of 100:10:8, and a resulting mixture was made to pellets with a particle size of 20 mm;
(3) the pellets were subjected to roasting in a rotary kiln at a temperature of 850° C. for 25 min; and
(4) the roasted pellets were subjected to smelting in an electric furnace at a temperature of 1,800° C. to obtain a finished ferronickel product.

### Test Example

1. The chemical compositions of the chromium concentrates obtained in Examples 1 to 3 and the mineral aggregate in Comparative Example 4 each were tested, and test results were shown in Table 2.

TABLE 2
Chemical composition test results (%)

| | Ni | Fe | MgO | Al₂O₃ | Cr₂O₃ | Co | SiO₂ |
|---|---|---|---|---|---|---|---|
| Example 1 | 0.12 | 14.97 | 13.03 | 28.37 | 36.37 | 0.25 | 0.29 |
| Example 2 | 0.12 | 15.23 | 12.89 | 28.48 | 36.63 | 0.24 | 0.30 |
| Example 3 | 0.15 | 15.01 | 12.54 | 28.26 | 36.87 | 0.26 | 0.28 |
| Mineral aggregate | 0.67 | 13.98 | 14.28 | 8.11 | 4.39 | 0.23 | 21.45 |
| in Comparative | | | | | | | |
| Example 4 | | | | | | | |

It can be seen from Table 2 that a percentage of Cr₂O₃ in the chromium concentrate obtained by the method for producing ferronickel and removing chromium from nickel laterite ore of the present disclosure is 36.37% or higher, which achieves the enrichment of chromium and reduces a chromium content in tailings.
2. The chromium-containing filtrates obtained in Examples 1 to 3 and Comparative Examples 1 to 3 each were tested for a chromium concentration, and test results were shown in Table 3.

TABLE 3
Chromium concentrations in the chromium-containing filtrate

| | Cr (g/Kg) | Leaching rate/% |
|---|---|---|
| Example 1 | 1.59 | 99.3 |
| Example 2 | 1.38 | 95.7 |
| Example 3 | 1.13 | 93.4 |
| Comparative Example 1 | 0.91 | 56.8 |
| Comparative Example 2 | 0.78 | 54.1 |
| Comparative Example 3 | 0.61 | 50.4 |

It can be seen from Table 3 that a concentration of Cr in the chromium-containing filtrate obtained by the method for producing ferronickel and removing chromium from nickel laterite ore of the present disclosure reaches 1.13 g/kg or higher, and a leaching rate of chromium reaches 93.4% or higher, indicating that the chromium element is well separated from the ore slurry to reduce a chromium content in the raw material for ferronickel production, which protects a furnace and reduces a chromium impurity content in the ferronickel. In addition, it can be seen from the comparison between Example 1 and Comparative Example 1, between Example 2 and Comparative Example 2, and between Example 3 and Comparative Example 3 that, when the high-pressure oxygen is not introduced during the oxidation leaching of the ore slurry, the leaching of chromium in the ore slurry is greatly reduced.
3. The finished ferronickel products obtained in Examples 1 to 3 and Comparative Examples 1 to 4 each were tested for a chromium content, and test results were shown in Table 4.

TABLE 4
Chromium content in the finished ferronickel product

| | Cr/% |
|---|---|
| Example 1 | 0.006 |
| Example 2 | 0.034 |
| Example 3 | 0.053 |
| Comparative Example 1 | 0.14 |
| Comparative Example 2 | 0.077 |
| Comparative Example 3 | 0.12 |
| Comparative Example 4 | 0.23 |

It can be seen from Table 4 that a concentration of Cr in the finished ferronickel product obtained by the method for producing ferronickel and removing chromium from nickel laterite ore of the present disclosure is lower than 0.053%. In addition, it can be seen from the comparison between Example 1 and Comparative Example 1, between Example 2 and Comparative Example 2, and between Example 3 and Comparative Example 3 that, when the high-pressure oxygen is not introduced during the oxidation leaching of the ore slurry, the chromium content in the final ferronickel product is increased.

The above examples are preferred implementations of the present disclosure. However, the implementations of the present disclosure are not limited by the above examples. Any change, modification, substitution, combination, and simplification made without departing from the spiritual essence and principle of the present disclosure should be an equivalent replacement manner, and all are included in the protection scope of the present disclosure.

1. A method for producing ferronickel and removing chromium from nickel laterite ore, comprising the following steps:
(1) subjecting the nickel laterite ore to ore washing and separating to obtain an ore slurry and a mineral aggregate, adding an alkali liquor and a bromate and introducing oxygen to the ore slurry to allow oxidation leaching, and then conducting solid-liquid separation to obtain a solid and a chromium-containing filtrate;
(2) subjecting the solid obtained in step (1) to washing and solid-liquid separation to obtain a solid phase and washing water, and mixing the solid phase with quicklime and a reducing agent to obtain a mixture; and
(3) subjecting the mixture obtained in step (2) to roasting and smelting successively to obtain a finished ferronickel product.

2. The method for producing ferronickel and removing chromium from nickel laterite ore according to claim 1, wherein in step (1), the ore slurry has a solid content of 10% to 25%.

3. The method for producing ferronickel and removing chromium from nickel laterite ore according to claim 1, further comprising: subjecting the mineral aggregate obtained in step (1) to crushing and re-separation in a shaker to obtain chromium concentrate and tailings, and returning the tailings for the ore washing.

4. The method for producing ferronickel and removing chromium from nickel laterite ore according to claim 1, wherein in step (1), for the oxidation leaching, a mass ratio of the alkali liquor to the bromate to the ore slurry is (0.5-1):(1-2):100.

5. The method for producing ferronickel and removing chromium from nickel laterite ore according to claim 1, wherein in step (1), the oxidation leaching is conducted under an enclosed condition, and a pressure of the oxygen is 1.5 MPa to 4 MPa.

6. The method for producing ferronickel and removing chromium from nickel laterite ore according to claim 1, wherein in step (1), the oxidation leaching is conducted at a temperature of 100° C. to 150° C. for 1 h to 5 h.

7. The method for producing ferronickel and removing chromium from nickel laterite ore according to claim 1, wherein the washing water obtained in step (2) is returned to step (1) for the ore washing.

8. The method for producing ferronickel and removing chromium from nickel laterite ore according to claim 1, wherein in step (2), a mass ratio of the quicklime to the reducing agent to the solid phase is (2-10):(3-8):100.

9. The method for producing ferronickel and removing chromium from nickel laterite ore according to claim 1, wherein in step (3), the roasting is conducted at a temperature of 600° C. to 1,000° C. for 10 min to 50 min.

10. The method for producing ferronickel and removing chromium from nickel laterite ore according to claim 1, wherein in step (3), the smelting is conducted at a temperature greater than or equal to 1,500° C.
